(19) United States
(12) Patent Application Publication
(10) Pub. No.: US 2022/0360990 A1
(43) Pub. Date: Nov. 10, 2022

(54) 4G / 5G CORE NETWORK DEEP PACKET INSPECTION SYSTEM

(71) Applicant: Rohde & Schwarz GmbH & Co. KG, Munich (DE)

(72) Inventor: Stefan URBAN, Wurzen (DE)

(21) Appl. No.: 17/308,660

(22) Filed: May 5, 2021

(51) Int. Cl. H04W 12/122; H04L 12/26; H04L 29/06

(52) U.S. Cl. CPC H04W 12/122; H04L 43/18; H04L 63/0281; H04L 63/1416; H04L 63/10

(57) ABSTRACT

The present disclosure relates to a 4G or 5G core network system (10). The system (10) comprises a plurality of network functions (15) in a 4G or 5G core network (11), wherein the network functions (15) are configured to communicate with each other using data packets. The system (10) further comprises at least one deep packet inspection (DPI) engine (13) which is configured to process the data packets and to analyze a protocol stack of said data packets in order to detect security-relevant activities in the 4G or 5G core network (11).

### TECHNICAL FIELD

The present disclosure relates generally to deep packet inspection in 4G and 5G core networks. In particular, the present disclosure relates to a 4G or 5G core network system, which is capable of performing deep packet inspection, to a deep packet inspection method for a 4G or 5G core network and to the use of such a method in a 4G or 5G core network.

### BACKGROUND ART

In general, a 4G or 5G network comprises a core network and a radio access network (RAN). The core network provides many of the key network functions of the network, while the RAN provides a connection between a user equipment, e.g. a mobile device, and the network.

Deep packet inspection is a method in network technology to process and inspect data that is sent over a network, e.g. for network analytics. It is known to use deep packet inspection in 5G networks to provide key network functions, such as application awareness or flow prioritization. For example, during deep packet inspection, data from several layers, e.g. layers 3 to 7, of an OSI layer stack are examined on a per-packet basis.

For example, the document U.S. Pat. No. 8,284,786 B2 discloses a method and a system that perform a context aware deep packet inspection in a mobile IP data network. For doing so, the method and system collect real time data from mobile IP data sessions, analyze the real time data and differentiate user data traffic from control traffic. Then, the method and system extract control information from the control traffic and create a subscriber context.

A further important aspect of 4G/5G networks is network security and resilience. For example, it is known to use techniques such as port matching to enhance the security of 4G and 5G networks and systems.

### SUMMARY

Thus, it is an objective to provide an improved 4G or 5G core network system, and an improved deep packet inspection method for a 4G or 5G core network.

The objective is achieved by the embodiments provided in the enclosed independent claims. Advantageous implementations of the embodiments of the present disclosure are further defined in the dependent claims.

According to a first aspect, the present disclosure relates to a 4G or 5G core network system, comprising a plurality of network functions in a 4G or 5G core network, wherein the network functions are configured to communicate with each other using data packets; and at least one deep packet inspection (DPI) engine which is configured to process the data packets and to analyze a protocol stack of said data packets in order to detect security-relevant activities in the 4G or 5G core network.

This achieves the advantage that deep packet inspection is used to increase the security of the 4G or 5G network. In this way, security-relevant activities, such as unwanted intrusions in the network can be quickly and efficiently detected.

The 4G or 5G core network system can be comprised in a 4G respectively 5G core network and can form a part or component of the 4G or 5G core network. The core network can be connected to a 4G or 5G RAN network. The at least one DPI engine may refer to one or more DPI engines in the core network.

Besides 4G and 5G, the core network system can be adapted for newer generation technology standards. For example, the system can also be a 6G core network system, comprising a plurality of network functions in a 6G core network. The functionality of such a 6G core network system and of its components can be essentially identical to the core network system for 4G and 5G.

The protocol stack may refer to a set of protocols, e.g. HTTP, TCP, IPv6, and their corresponding layers, e.g. application, transport, network. In particular, the protocol stack may be configured according to the OSI model.

In particular, the term network functions may refer to network function entities or network function modules. These network function entities or modules can be implemented in the 4G or 5G core network via software, via hardware or via a software/hardware combination. For example, at least one of the network functions can be formed as a virtual entity by executing a dedicated software or software package. Examples of such network functions are: a session management function, an authentication server function, or an access and mobility management function which establishes a connected to a 4G or 5G RAN.

In an embodiment, the at least one DPI engine is configured to detect, as said security-relevant activities, unwanted intrusions in the 4G or 5G core network.

In an embodiment, the system is configured to block said unwanted intrusions.

In an embodiment, the system further comprises a service communication proxy which is configured to mediate the communication between the network functions.

In an embodiment, the service communication proxy comprises one of the at least one DPI engines.

By implementing the DPI engine in the service communication proxy, which mediates the communication in the core network, any communication that is handled by the service communication proxy can be immediately analyzed by the DPI engine.

The service communication proxy can be implemented in the 4G or 5G core network in the form of a service communication proxy module or unit. The service communication proxy can, thereby, be a virtual network module. Alternatively, the service communication proxy can at least partially be implemented via hardware, e.g. via a processor and memory, in the 4G or 5G network. The core network may be configured according to Model C (managed services) or Model D (fully managed services) of 5G.

The term DPI engine may refer to a DPI module or DPI unit that is comprised by the service communication proxy. In particular, the DPI engine can be a virtual module, e.g. a software module that is executed by an entity of the core network. For example, the service communication proxy is at least partially formed by executing a dedicated software package. The DPI engine can comprise a DPI probe.

The DPI engine can be configured to perform protocol analysis in all service communication proxy network functions that receive all NF communication, in particular NF/NF (network function to network function) communication.

In an embodiment, the system comprises two or more of the DPI engines; wherein at least two of the plurality of network functions comprise a respective one of the two or more DPI engines.

In an embodiment, the at least two of the plurality of network functions are associated with the control plane of the 4G or 5G core network.

For example, the network functions comprising the DPI engines are network functions in or for the control plane of the 4G or 5G core network. The core network may be configured according to Model A, Model B, Model C or Model D of 5G.

In particular, the DPI engines that are comprised by the at least two network functions are configured to perform a deep packet inspection on the control plane of the core network. In this way, security on the control plane of the core network can be further enhanced.

In one example, all network functions within the control plane of the 4G or 5G core network comprise a respective DPI engine.

If the DPI engines are comprised by both the service communication proxy and the network functions, the DPI engines in the network functions can be “lite” DPI engines, i.e. they may have a limited functionality compared to the DPI engine of the service communication proxy.

In an embodiment, at least one of the plurality of network functions does not comprise a DPI engine.

In particular, at least one network function does not comprise a full DPI engine, such as the DPI engine in the service communication proxy.

In an embodiment, the system further comprises a network repository function module which comprises one of the at least one DPI engines.

In particular, network function or network service discovering can be performed by the service communication proxy (fully managed) or by the network functions (managed interactions). In case of managed interactions, the network repository function module that provides the network function or network service discovery comprises one of the DPI engines.

In an embodiment, the at least one DPI engine is configured to analyze the entire protocol stack of the data packets in order to detect the security-relevant activities.

For example, by processing and analyzing the protocol stack, in particular the entire protocol stack, the service communication proxy may obtain full protocol awareness.

In an embodiment, the network functions are virtual network functions in the 4G or 5G core network.

According to a second aspect, the present disclosure relates to a deep packet inspection method for a 4G or 5G core network, wherein the method comprises:
processing data packets that are communication between a plurality of network functions in the 4G or 5G core network by means of deep packet inspection; and, thereby,
analyzing a protocol stack of said data packets in order to detect security-relevant activities in the 4G or 5G core network.

In an embodiment, the method further comprises:
detecting, as said security-relevant activities, unwanted intrusions in the 4G or 5G core network.

In an embodiment, the method further comprises:
blocking said unwanted intrusions.

For example, the step of processing of the data packets is carried out by a DPI engine, wherein the method further comprises the step:
mediating a communication between the plurality of network functions in the 4G or 5G core network by means of a service communication proxy, wherein the service communication proxy comprises the DPI engine.

In another example, the step of processing of the data packets is carried out by two or more DPI engines, wherein each of said DPI engines is comprised in a network function in the control plane of the 4G or 5G network.

The deep packet inspection method may be adapted for newer generation technology standards, such as 6G. For example, the network functions can be arranged in a 6G core network, and the method can be used to detect security-relevant activities in the 6G core network.

According to a third aspect, the present disclosure relates to the use of the method according to the second aspect of the present disclosure for intrusion detection in a 4G or 5G core network.

### BRIEF DESCRIPTION OF THE DRAWINGS

The above described aspects and implementation forms of the present disclosure will be explained in the following description of specific embodiments in relation to the enclosed drawings, in which:

FIG. 1 shows a schematic diagram of a 4G or 5G core network system according to an embodiment;

FIG. 2 shows a schematic diagram of a 4G or 5G core network system according to an embodiment;

FIG. 3 shows a schematic diagram of a 4G or 5G core network system according to an embodiment; and

FIG. 4 shows a flow diagram of a deep packet inspection method for a 4G or 5G core network according to an embodiment.

### DETAILED DESCRIPTIONS OF EMBODIMENTS

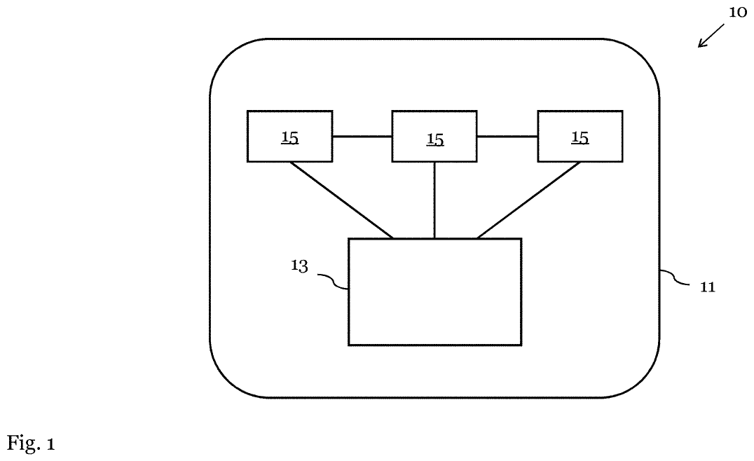

FIG. 1 shows a schematic diagram of a 4G or 5G core network system 10 according to an embodiment.

The system 10 comprises a service communication proxy 12 and a plurality of network functions 15 in the 4G or 5G core network 11. The network functions 15 are configured to communicate with each other using data packets. The system 10 further comprises at least one deep packet inspection (DPI) engine 13 which is configured to process said data packets and to analyze a protocol stack of the data packets in order to detect security-relevant activities in the 4G or 5G core network 11.

The DPI engine 13 can be implemented as a DPI module or DPI unit. In particular, the DPI engine 13 is a virtual module or unit, i.e. the DPI engine 13 is implemented via software in the core network 11.

In particular, the DPI engine 13 can be configured to analyze the entire protocol stack of the data packets with regard to the security-relevant aspects of the core network 11. Alternatively, the DPI engine 13 may be configured to analyze several layers of the layer stack, e.g. layers 3 to 7 if the protocol stack is configured according to the OSI model. The DPI engine 13 can be configured to correlate information at the analyzed layers and to detect the security-relevant activities. In addition, the DPI engine 13 can be configured to detect applications and their related attributes/parameters based on the correlated information.

The system 10 can be implemented in the core network 11 via hardware and/or software.

The network functions 15 can be network function entities or modules. The system 10 can comprise these network function entities or modules. In particular, the network functions 15 may be virtual network functions in the core network 11. For example, one, more or all of the network functions 15 can be formed as virtual entities by executing dedicated software. Alternatively, the network functions 15 might also be implemented via hardware or a combination of hardware and software. Although only three network functions 15 are depicted in FIG. 1, the system 10 may comprise any number of network functions 15.

The system 10 may also be implemented in a core network according to a higher generation technology standard, e.g. a 6G core network.

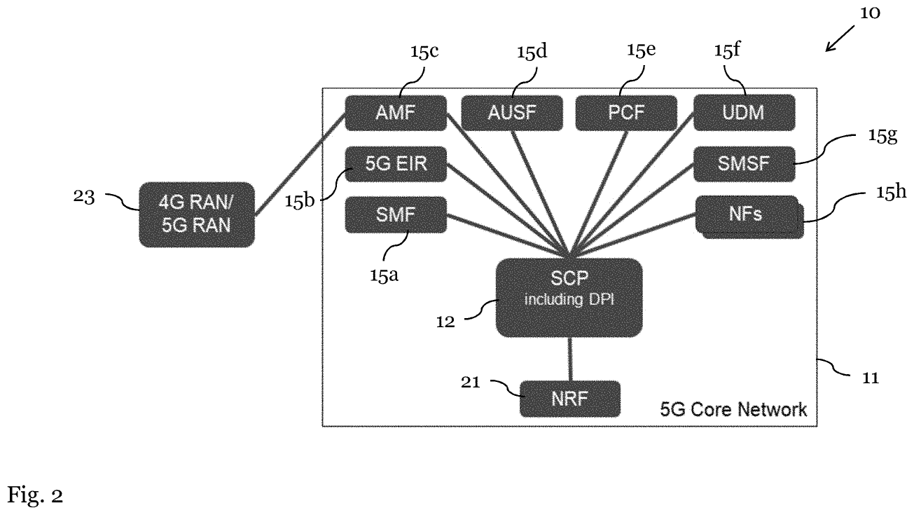

FIG. 2 shows a schematic diagram of the 4G or 5G core network system 10 according to an embodiment.

In the embodiment shown in FIG. 2, the system 10 comprises a service communication proxy 12, wherein this service communication proxy 12 is configured to mediate the communication between the network functions 15a-h. The service communication proxy 10 in FIG. 2 comprises one of the DPI engines 13.

In particular, the core network 11 in FIG. 2 is a 5G core network.

The service communication proxy 12 can be configured to detect via its DPI engine 13 unwanted intrusions in the 5G core network 11. In this way, the security of the 5G network can be enhanced. By implementing the DPI engine 13 in the service communication proxy 12 any communication that is handled by the service communication proxy 12 can be immediately analyzed by the DPI engine 13 and unwanted intrusions or other security-relevant activities in the network can be quickly and efficiently detected. Thus, the service communication proxy 12 provides a centralized security instance of the 5G core network that may analyze any communication in the network 11 with regard to security-relevant activities.

Upon detection of an unwanted intrusion, the service communication proxy 12 can be configured to block said unwanted intrusions.

Alternatively or additionally, the service communication proxy 12 may be configured to trigger further actions upon detection of an unwanted intrusion. For example, the service communication proxy 12 may issue a notification on the detection of the unwanted intrusion or its successful blocking to another entity in the network, and/or the service communication proxy 12 may trigger another entity in the 5G core network 11, e.g. a network function 15, to block the unwanted intrusion.

The DPI engine 13 can be configured to perform protocol analysis in all service communication proxy 12 network functions that receive NF communication, in particular NF/NF communication.

The service communication proxy 12 can provide several further functions to the core network 11, such as routing control, security, resiliency, and observability. For example, the service communication proxy 12 may analyze the data packets to carry out further tasks, such as providing flow prioritization or application awareness. The service communication proxy 12 can, thereby, interact with a NF Repository Function (NRF) module of the core network 11.

At least one of the plurality of network functions 15 may comprise a further one of the DPI engines 13. For example, the further DPI engine can be “lite” DPI engine, i.e. DPI engine with a limited functionality compared to the DPI engine 13 of the service communication proxy 12. The further DPI engine can be virtual module or unit, i.e. implemented via software.

For example, the further DPI engines that are implemented in at least one of the network functions 15 may also be configured to process and analyze data packets that are exchanged between network functions to detect security-relevant activities in the core network. In particular, there may exist some level of cooperation between the DPI engine in the service communication proxy and the DPI engine(s) in the at least one network function.

In particular, at least one of the plurality of network functions 15 may not comprise a further DPI engine or may not comprise a full DPI engine, such as the DPI engine in the service communication proxy 12.

The system 10 shown in FIG. 2 further comprises an NF repository function (NRF) module 21. For example, the NRF module can store profiles of all NF/NF (network function to network function) service instances.

The NRF module 21 may comprise a further DPI engine, in particular in case of managed communication. For example, the NRF module 21 with the further DPI engine may provide network service discovery.

The system 10 shown in FIG. 2 comprises a plurality of network functions 15a-h, such as: a 5G session management function 15a, a 5G equipment identity register function 15b, an access and mobility management function 15b, which is connected to a 4G or 5G RAN 23, an authentication server function 15d, a policy control function 15e, a unified data management function 15f, a short message service function 15g, and further network functions 15h. However, the set of network functions 15a-h shown in FIG. 2 are only an example and the system 10 may comprise any combination of these network functions 15a-h and/or further network functions.

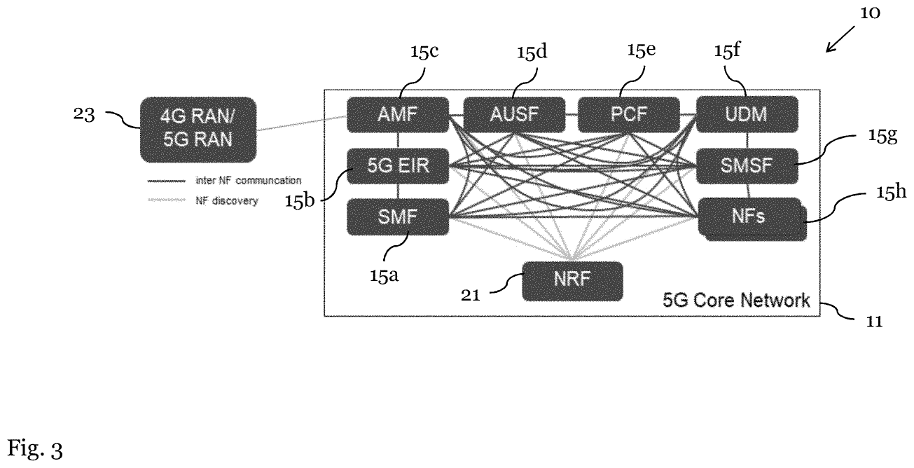

FIG. 3 shows a schematic diagram of the 4G or 5G core network system according to another embodiment. In the embodiment shown in FIG. 3, at least two of the network functions comprise a respective DPI engine 13.

The network functions that comprise the DPI engine 13 are, preferably, associated with a control plane of the core network 11, i.e. they are network functions in the control plane of the core network 11. In particular, these DPI engines 13 are control plane DPI engines, i.e. DPI engines 13 operating on the control plane of the core network 11.

In particular, all of the network functions 15a-h may comprise a respective DPI engine 13 that is analyzing the protocol stack for security-relevant activities.

By implementing the DPI engines in core network functions, a core network 11 with decentralized security via deep packet inspection can be provided. The network functions which comprise the DPI engines 13 can be configured to process and/or control data in the core network 11. Thus, these network functions can be configured, upon detection of unwanted intrusions in the core network 11, to block said intrusions.

The network functions 15a-h may be static provisioned network functions or discovered network functions. Preferably, the network functions 15a-h are virtual network functions. As in FIG. 2, the set of network functions 15a-h shown in FIG. 3 are only an example and the system 10 may comprise any combination of these network functions 15a-h and/or further network functions.

The core network 11 shown in FIG. 3 may be a 4G core network or a 5G core network.

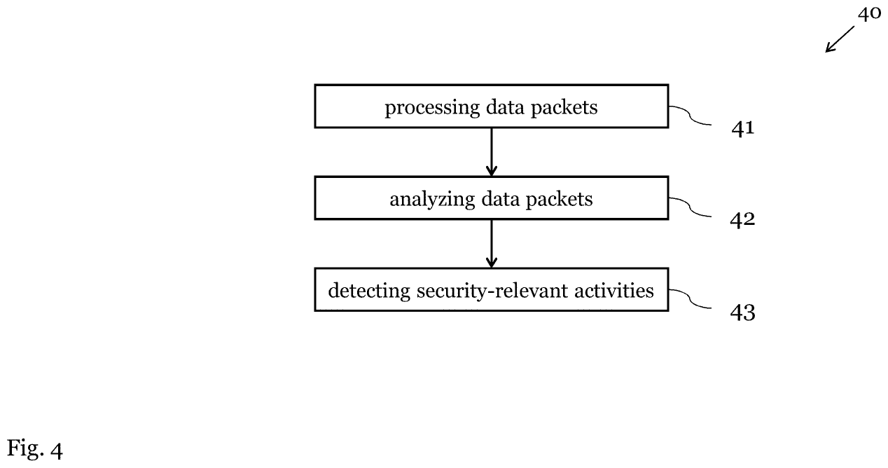

FIG. 4 shows a flow diagram of a deep packet inspection method 40 for the 4G or 5G core network 11 according to an embodiment.

The method 40 comprises the steps of:
processing 41 data packets that are communication between the plurality of network functions 15 in the 4G or 5G core network 11 by means of deep packet inspection (DPI); and, thereby,
analyzing 42 the protocol stack of said data packets in order to detect 43 security-relevant activities in the 4G or 5G core network.

In particular, unwanted intrusions in the core network 11 can be detected as security-relevant activities by the method 40.

The method 40 may further comprise the step of blocking said unwanted intrusions.

The method 40 can be used for threat detection and, particularly, for intrusion detection in the core network 11.

All features of all embodiments described, shown and/or claimed herein can be combined with each other.

1. A 4G or 5G core network system, comprising:
a plurality of network functions in a 4G or 5G core network;
wherein the network functions are configured to communicate with each other using data packets; and
at least one deep packet inspection (DPI) engine which is configured to process the data packets and to analyze a protocol stack of said data packets in order to detect security-relevant activities in the 4G or 5G core network.

2. The system according to claim 1,
wherein the at least one DPI engine is configured to detect, as said security-relevant activities, unwanted intrusions in the 4G or 5G core network.

3. The system according to claim 2,
wherein the system is configured to block said unwanted intrusions.

4. The system according to claim 1, further comprising:
a service communication proxy which is configured to mediate the communication between the network functions.

5. The system according to claim 4,
wherein the service communication proxy comprises one of the at least one DPI engines.

6. The system according to claim 1,
wherein the system comprises two or more of the DPI engines;
wherein at least two of the plurality of network functions comprise a respective one of the two or more DPI engines.

7. The system according to claim 6,
wherein the at least two of the plurality of network functions are associated with the control plane of the 4G or 5G core network.

8. The system according to claim 1,
wherein at least one of the plurality of network functions does not comprise a DPI engine.

9. The system according to claim 1,
wherein the system further comprises a network repository function module which comprises one of the at least one DPI engines.

10. The system according to claim 1,
wherein the at least one DPI engine is configured to analyze the entire protocol stack of the data packets in order to detect the security-relevant activities.

11. The system according to claim 1,
wherein the network functions are virtual network functions in the 4G or 5G core network.

12. A deep packet inspection method for a 4G or 5G core network, wherein the method comprises:
processing data packets that are communication between a plurality of network functions of the 4G or 5G core network by means of deep packet inspection (DPI); and, thereby,
analyzing a protocol stack of said data packets in order to detect security-relevant activities in the 4G or 5G core network.

13. The method according to claim 12, further comprising:
detecting, as said security-relevant activities, unwanted intrusions in the 4G or 5G core network.

14. The method according to claim 13, further comprising:
blocking said unwanted intrusions.

15. Use of the method according to claim 12 for intrusion detection in a 4G or 5G core network.
